(19) United States
(12) Patent Application Publication
(10) Pub. No.: US 2017/0101948 A1
(43) Pub. Date: Apr. 13, 2017

(54) MONITORING AN ENGINE BY MEANS OF CYLINDER PRESSURE SENSORS, PREFERABLY IN LEAN GAS ENGINES WITH A FLUSHED PRECHAMBER

(71) Applicant: MTU Friedrichshafen GmbH, Friedrichshafen (DE)

(72) Inventor: Christian KUNKEL, Augsburg (DE)

(21) Appl. No.: 15/310,636

(22) PCT Filed: May 8, 2015
(86) PCT No.: PCT/EP2015/000945

§ 371 Date: Nov. 11, 2016

(30) Foreign Application Priority Data
May 13, 2014 (DE) 10 2014 007 009.3

(51) Int. Cl. F02D 41/00; F02B 19/12; F02D 41/22; F02D 31/00; F02D 35/02; F02B 19/10; F02B 43/04

(52) U.S. Cl. CPC F02D 41/0027; F02B 19/1085; F02B 19/12; F02B 43/04; F02D 31/007; F02D 35/023; F02D 35/026; F02D 35/027; F02D 41/222; F02D 2200/1002

(57) ABSTRACT

A method for operating an internal combustion engine, in particular a gas engine, preferably a lean gas engine, which has at least one cylinder, in order to improve the combustion process, a prechamber is provided for igniting a mixture in a main chamber. A pressure curve is detected by a pressure sensor in the main chamber dependent on a crank angle, and the quantity of supplied fuel is controlled or regulated for each individual cylinder using a fuel metering device and the pressure sensor dependent on a desired output and/or a desired torque and/or a desired rotational speed of the internal combustion engine.

The invention relates to a method for operating an internal combustion engine which has at least one cylinder, in particular for operating a gas engine, preferably a lean gas engine.

Engines on the market with bore diameters of more than approximately 250 mm are primarily operated with what is known as a flushed prechamber on account of the long flame paths, in order to ignite the homogeneous mixture as rapidly as possible and therefore in an optimum manner in terms of the degree of efficiency. This technology is also increasingly establishing itself in the case of smaller bore diameters. In order to improve the ignition conditions at the spark plug, the mixture is enriched in a prechamber. To this end, additional fuel gas is introduced into the prechamber via a gas injection valve. Stable ignition of the prechamber charge is ensured in this way. The torch jets which exit from the prechamber make reliable ignition of the main combustion chamber charge possible up to compression air ratios of approximately 2.7, the typical operating range lying at a combustion air ratio of approximately 2. Air ratios of this type cannot be ignited by way of conventional technology, such as an open plug or by means of an unflushed prechamber plug. The volume of flushed prechambers lies in the range from 0.5 to 4% of the compression volume. The engine, apart from the region in the prechamber, can be relieved thermally by way of said technology on account of the high combustion air ratio and the complete burn which is optimized in terms of the degree of efficiency. Furthermore, very low nitrogen oxide emissions and an extension of the knock limits can be achieved by way of the pronounced lean mixture capability.

Decoupling of the local flow conditions around the spark plug from the turbulent charge movement in the main combustion chamber is brought about by way of the use of split combustion chambers. In this way, lean mixtures can also be ignited reliably in large combustion chambers. A distinction is made between unflushed and flushed prechambers. Here, the prechamber is as a rule flushed with fuel gas during the gas exchange. During the compression stroke, fresh gas additionally passes into the prechamber, with the result that a near-stoichiometric mixture is present at the ignition time, which mixture can be ignited even more reliably and leads to more intensive prechamber combustion with ignition jets which penetrate more deeply into the main combustion chamber.

On account of the high temperatures in the case of stoichiometric combustion, an increased nitrogen oxide formation occurs in the prechamber. This is compensated for, however, by way of the lean combustion in the main combustion chamber and the associated low NOx formation. Viewed globally, lower nitrogen oxide values are possible in the case of well tuned chamber geometries and/or volumes than in the case of engines with an unsplit combustion chamber. Even leaner setting of the main charge would be possible by way of a further increase in the prechamber volume. The emissions advantage of the lean combustion would then be reduced again, however, by way of the increased nitrogen oxide formation in the prechamber.

Furthermore, there is also an urgent need to lower the emissions of internal combustion engines and to make rapid and precise adaptation of the output power to the load requirements possible.

This object is achieved by way of the features of patent claim 1. Further advantageous refinements of the invention are in each case the subject matter of the subclaims. They can be combined with one another in a technologically appropriate way. The description, in particular in conjunction with the drawing, additionally characterizes and specifies the invention.

In a method for operating an internal combustion engine which has at least one cylinder, in particular in a gas engine, preferably a lean gas engine, the object is achieved by virtue of the fact that a prechamber is provided for igniting a mixture in a main chamber, the pressure gradient being determined by a pressure sensor in the main chamber in a manner which is dependent on a crank angle, and the supplied quantity of fuel into the prechamber and/or into the main chamber preferably being controlled or regulated for each individual cylinder with the aid of the pressure sensor in a manner which is dependent on a desired power output and/or a desired torque and/or a desired rotational speed of the internal combustion engine. In the case of load changes, with the aid of a sensor system which detects the pressure gradient in the cylinder in a manner which is dependent on the crank angle of the combustion profile, and therefore also the power output of the individual cylinder are detected computationally. If, for example, the separately measured rotational speed increases, the supply of fuel gas into the intake line of the cylinder can be reduced, in order thus to keep the rotational speed constant.

In the case of more than one cylinder, the cylinders can be compared with one another with the aid of what is known as a cylinder pressure indication system which serves to detect the internal pressure which prevails in the cylinder in a manner which is dependent on the crankshaft angle or time, in order, for example, to detect faults or to set the fuel supply for each individual cylinder in such a way that the combustion process is operated in the optimum range in every cylinder. To this end, variables which are determined computationally from the cylinder pressure such as the center of combustion mass and/or the mean pressure can be used.

An equalization of the combustion in the prechamber can advantageously be achieved by way of evaluation of a conversion peak which is produced in the main combustion chamber by way of the prechamber combustion. In addition, monitoring of the prechamber gas valves is possible. Prechamber gas valves can have different manufacturing tolerances or injection dimensions, since they are adjusted. This results in cost advantages during manufacture. Equalized prechamber combustion ensures that every cylinder has a similar to identical combustion, and therefore the overall engine is operated in an optimum manner in terms of the degree of efficiency.

In the case of mechanical valves, the equalization can take place via the valve-individual gas pressure, and in the case of electrically actuated valves, the equalization can preferably take place via the actuation duration and the gas pressure.

By way of the regulation of the prechamber gas valve, the equalization can take place via the measurement of the conversion peak which is produced by way of the prechamber combustion and setting thereof to a setpoint peak.

It is provided in one refinement of the method that the prechamber is flushed during every cycle, and a fuel, preferably gas, is introduced for ignition into the prechamber via a prechamber valve. The reliable ignition of the charge in the prechamber can also be monitored reliably with the aid of the cylinder pressure indication system. The ignition in the prechamber can be detected by way of a peak in the rising branch of the pressure gradient, but also, in particular, of the heat release rate or combustion profile. Said pressure gradient is linked via known formulae to the amount of heat which is released as a result of the combustion. The quantity of fuel which is injected via the prechamber valve can be used for what is known as equalization of the cylinders.

It is proposed in a further refinement of the method that an indicator quartz, a pressure sensor with strain gage technology, or an optical pressure sensor which operates by way of optical measuring methods (for example, by means of laser interference) is used as pressure sensor. It can be determined, in particular, in conjunction with further measured variables, such as the exhaust gas temperature at the cylinder outlet or by means of evaluation and comparison of the rotational non-uniformity with a setpoint value, whether the combustion in a cylinder actually differs from the remaining cylinders. As a result, it can also be detected, for example, whether the cylinder pressure sensor of the relevant cylinder is defective.

If the pressure gradient, preferably the heat release rate or combustion profile, is evaluated for the appearance of a gradient peak in the rising branch of the pressure gradient, preferably of the heat release rate or combustion profile, this is an indication that the prechamber ignition has taken place. Moreover, the monitoring of cycle-based limits in terms of combustion such as knocking or misfiring operation, and the optimization over a plurality of cycles and the monitoring and reaction to varying gas quality can be made possible with the aid of a cylinder pressure indication system. Said information is also used to equalize the cylinders.

By virtue of the fact that the temperature in the unburned region of a known and frequently used two zone model is determined computationally by means of preferably a pressure gradient analysis, this signal can advantageously be used in the case of a known methane number to determine the gap from a knock threshold and/or can serve to predict knocking behavior. This information can then be processed further by the controller in such a way that operating states of this type are avoided.

Thus, adaptive pilot control and/or regulation of an air ratio can also advantageously take place in such a way that no knocking occurs. In particular in the case of an increase in the load, this value can be used to enrich the combustion chamber at a defined knocking gap to such an extent that the result is maximum load connection without knocking operation and without an intervention of the knock control system.

As an alternative or in addition, control or regulation of an ignition time can also take place adaptively.

The same applies for the refinement of the method, namely that adaptive pilot control and/or regulation of an introduced volume of the prechamber gas valve take/takes place.

A quartz defect, in particular in the case of piezoresistive sensors, can advantageously also be detected if an integration of the pressure signal takes place. If the gradient at the end of the integrated signal is not horizontal or zero, this can be an indication of a defect of the sensor, or the engine and corresponding measuring technology are not functioning as intended.

Further state variables can be determined by way of splitting of the combustion chamber for the pressure gradient analysis into two zones, namely the burned and the unburned zone, and by way of the temperature which is calculated in the unburned zone. It is possible, for example, to determine the methane number of the fuel gas which as a rule changes only very slowly during operation, by the knock limit being approached and the latter being compared with a stored characteristic diagram. Thus, in addition to what has been mentioned above, the methane number of the fuel gas can be determined as required and can be utilized for regulation, for example, of maximum enriching for transient operations for an improved pilot control of the transient process. In the case of applications, in which the methane number can change suddenly, for example mobile stationary power generation or applications, in which filling operations take place, a determination of the methane number is particularly preferably carried out as far as possible directly after engine starting. Furthermore, it is possible, with a knowledge of said methane number, to determine a knock gap as a temperature difference in the unburned zone, without it being necessary to approach engine knocking. In this way, a check of engine operation which conforms with the fuel is also possible, that is to say compliance with the minimum methane number.

In transient engine operation which is optimized by way of mixture enriching in the main combustion chamber, regulation to said knock limit, optionally with a little safety gap, can be carried out very rapidly, without it being necessary for the engine to be made to knock directly and it being necessary for the knock control system to intervene. In this way, knocking operation which damages the engine can be minimized.

The emissions values of the internal combustion engine can be reduced, and/or the degree of efficiency of the overall engine can be maximized, if equalization of a plurality of cylinders takes place by way of setting or equalizing of an air ratio via the prechamber gas valve in the prechamber.

In a further refinement, the method advantageously provides that an automatic check of the engine and/or the pressure quartzes takes place by way of comparison of a cumulative heat release rate or cumulative combustion profile with a predetermined value. In this way, deviations between individual cylinders can be detected. Cylinders which are equalized in terms of the combustion profile can be compared in terms of their filling, in particular with regard to air consumption and a correctly functioning valve train or cylinder head, since differences in the converted fuel mass (this corresponds to the end sum in the cumulative combustion profile) also indicate differences in the air consumption.

It is provided in a further refinement of the invention that an indicated mean pressure is determined from the pressure gradient, and an effective power output of the internal combustion engine is calculated with consideration of a predetermined frictional power and is made available to a controller, preferably for the execution of protective measures. The effective power of the engine can be determined to a very good approximation with the aid of the indicated mean pressure and a knowledge of the frictional power which is known in the case of a mechanically and/or tribologically correctly functioning engine. During an additional measurement and/or derivation of the effective engine power output, said value can also be used to assess the mechanical and/or tribological state of the engine, and countermeasures or protective measures can possibly be performed by the control unit.

One preferred embodiment of the invention will be explained by way of example using a drawing, in which, in detail:

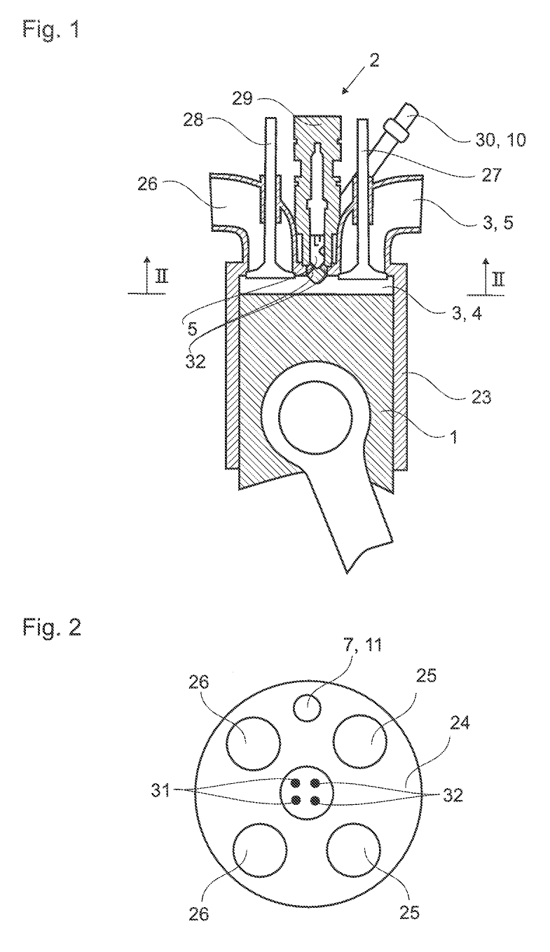

FIG. 1 shows a diagrammatic vertical section through a cylinder,

FIG. 2 shows a diagrammatic view of the cylinder head according to the viewing direction II-II in FIG. 1,

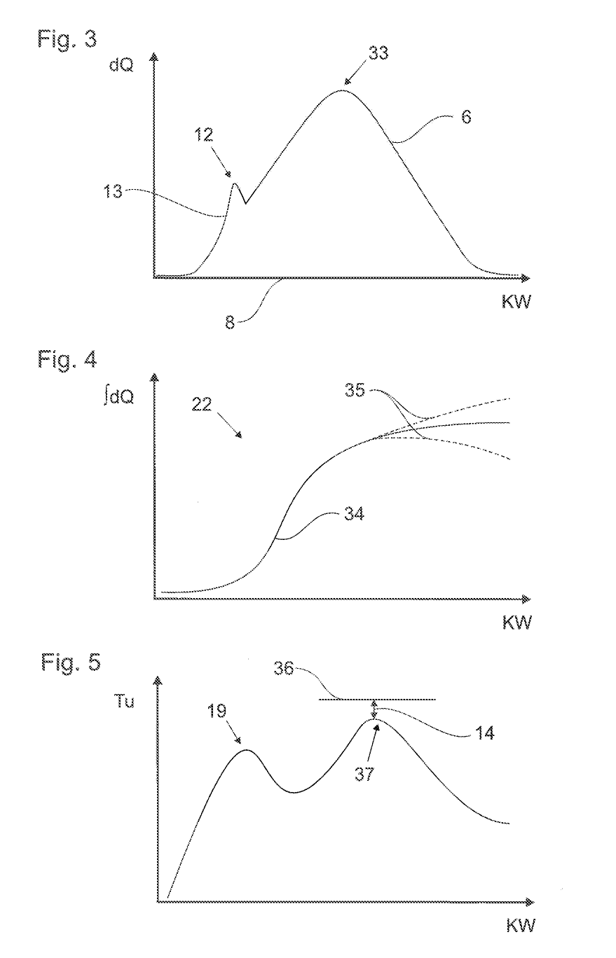

FIG. 3 shows a standardized heat release rate of a cylinder pressure indication system,

FIG. 4 shows the profile of the integrated heat release rate, and

FIG. 5 shows the standardized profile of a temperature measurement in the unburned zone, plotted against the crank angle.

FIG. 1 shows by way of example a vertical section through a cylinder of an internal combustion engine. FIG. 2 shows a diagrammatic view of the cylinder head according to the viewing direction II-II in FIG. 1.

The air/gas mixture 3 of a gas engine is burned in a main chamber 4. The cylinder 1 forms the outer lower boundary of the main chamber 4, the side walls are formed by the cylinder liner 23 which encloses the cylinder, and the cylinder head 24 (FIG. 2) closes the main chamber at the top. A mixture of air and gas flows through the inlet pipes 25 in a manner controlled by inlet valves 27 into said combustion chamber of the main chamber 4. After the ignition and combustion, the exhaust gas then leaves the combustion chamber 4 through the outlet pipes 26 (FIG. 2) in a manner which is controlled by way of the outlet valves 28.

The ignition device 29 (shown in FIG. 1) with its prechamber 5 serves to ignite the mixture, into which prechamber 5 an injection volume is as a rule injected into the prechamber 5 for ignition by way of an injection valve 30 as a prechamber valve 10 for ignition purposes. The introduction of the gas into the prechamber preferably takes place at a gas pressure level of up to 10 bar at the gas exchange bottom dead center. A high pressure gas injection in the compression stroke is also possible at pressures of up to 300 bar.

As soon as the gas mixture has ignited in the prechamber 5, ignition jets 31 leave the ignition openings 32 of the prechamber 5. The ignition jets then ignite the mixture 3 in the main chamber 4, which mixture 3 is situated and compressed in said main chamber 4.

In addition, a pressure sensor 7 for monitoring the main chamber 4 is arranged in the cylinder head, which pressure sensor 7 measures the pressure gradient 6 in a manner which is dependent on the crank angle 8. An indicator quartz 11 is used as pressure sensor 7, which indicator quartz 11 measures the pressure gradient 6 (shown in FIG. 3) in a manner which is dependent on the crank angle KW, and is fed as a signal for evaluation to a controller (not shown).

FIG. 3 shows a standardized heat release rate of this type or else heat release profile 6 which is obtained from the pressure gradient by means of heat release rate analysis. A profile peak 12 can be clearly seen in the rising branch 13 of the heat release rate 6, which profile peak 12 can be attributed to the ignition in the prechamber. Conclusions can be made from the position of the profile peak 12 with respect to the pressure maximum 33 about the dynamics of the combustion operation in the main chamber 4. The heat release rate 6 corresponds to the amount of heat dQ which is produced by way of the combustion.

The graph which is shown in FIG. 4 represents the integral of the heat release rate shown in FIG. 3 plotted against the crank angle. It therefore corresponds to the overall output or produced amount of heat of one individual ignition. The combustion sequence is concluded as soon as the cumulative combustion profile 34 ends horizontally. If the cumulative combustion profile 34 does not reach a horizontal discontinuation at the end, but rather the profiles 35 which are shown using interrupted lines, it is to be concluded herefrom that the pressure sensor 7 and/or the indicator quartz 11 are/is defective and/or there is another fault in the engine. These artefacts 35 are illustrated in FIG. 4 using interrupted lines.

FIG. 5 shows the temperature profile in the unburned zone from the two zone model. The temperature of the unburned zone Tu. The temperature of the knock threshold is indicated by a horizontal line 36. The maximum of the measured temperature 37 is at a gap 14 from said knock threshold 36. The controller can make a conclusion about the inherent reserves of the combustion process therefrom and/or avoid knocking states.

As soon as a load increase requirement is reported to the engine or to the controller by the operator or by the generator, the control unit determines the knock gap as a temperature difference, or takes a value from a preceding determination which is determined via deliberate approaching of the knock limit, or a value which corresponds to a methane number which is predetermined by the controller. The controller then causes the enrichment of the mixture up to the knock limit. This corresponds to the maximum permissible temperature in the unburned zone. In this way, the most satisfactory response behavior of the engine to load increase requirements can be achieved.

1-13. (canceled)

14. A method for operating an internal combustion engine which has at least one cylinder, comprising the steps of: providing a prechamber for igniting a mixture in a main chamber; determining a pressure gradient by a pressure sensor in the main chamber in a manner that is dependent on a crank angle; and controlling or regulating a supplied quantity of fuel into the prechamber and/or into the main chamber for each individual cylinder with aid of the pressure sensor in a manner dependent on a desired power output and/or a desired torque and/or a desired rotational speed of the internal combustion engine.

15. The method according to claim 14, including flushing the prechamber during every cycle, and introducing a fuel for ignition into the prechamber via a prechamber valve.

16. The method according to claim 15, wherein the fuel is gas.

17. The method according to claim 14, wherein the pressure sensor is an indicator quartz, a sensor with strain gage technology, or an optical sensor.

18. The method according to claim 14, including evaluating a pressure gradient for appearance of a gradient peak in a rising branch of the pressure gradient.

19. The method according to claim 18, wherein the pressure gradient is of heat release rate or combustion profile.

20. The method according to claim 14, including determining a temperature in an unburned region of a two zone model to define a gap from a knock threshold and/or a prediction of knocking behavior.

21. The method according to claim 14, wherein adaptive pilot control and/or regulation of an air ratio takes place.

22. The method according to claim 14, wherein adaptive pilot control and/or regulation of an ignition time takes place.

23. The method according to claim 14, wherein adaptive pilot control and/or regulation of an introduced volume of the prechamber gas valve takes place.

24. The method according to claim 14, wherein the pressure sensor is a piezoresistive sensor, the method including integrating a pressure signal from the sensor to detect a quartz defect.

25. The method according to claim 14, including dividing the combustion chamber into two zones for a pressure gradient analysis, namely into an unburned and a burned zone, and using temperature in the unburned zone to derive a knock interval for a current cycle at an operating point.

26. The method according to claim 14, including equalizing a plurality of cylinders by setting an air ratio via a prechamber gas valve in the prechamber.

27. The method according to claim 14, including carrying out an automatic check of the engine and/or the pressure sensor by comparing a cumulative heat release rate with a predetermined value.

28. The method according to claim 25, including determining an indicated mean pressure from the pressure gradient, and calculating an effective power output of the internal combustion engine with consideration of a predetermined frictional power, and making these available to a controller for executing protective measures.

29. The method according to claim 14, wherein the engine is a gas engine.

30. The method according to claim 29, wherein the engine is a lean gas engine.
